(19) United States
(12) Patent Application Publication
(10) Pub. No.: US 2009/0259670 A1
(43) Pub. Date: Oct. 15, 2009

(54) Apparatus and Method for Conditioning Semi-Structured Text for use as a Structured Data Source

(76) Inventor: William H. Inmon, Castle Rock, CO (US)

Correspondence Address: FOUNTAINHEAD LAW GROUP, PC, 900 LAFAYETTE STREET, SUITE 200, SANTA CLARA, CA, 95050, US

(21) Appl. No.: 12/102,577

(22) Filed: Apr. 14, 2008

(51) Int. Cl. G06F 17/30

(52) U.S. Cl. 707/100; 707/E17.058

(57) ABSTRACT

In one embodiment, the present invention includes a method for conditioning semi-structured text to enhance its use as a data source for an analytical processing tool. In general, the method involves analyzing the semi-structured text to identify portions of text (referred to herein as sub-documents) that exhibit a repetitive characteristic. Next, for each sub-document identified, the semi-structured text is integrated, for example, by filtering the text for relevant words, removing stop words, stemming certain words, adding or replacing certain words with synonyms, modifying the spelling of certain words, and/or resolving certain homonyms based on a document class assigned to the semi-structured text, and so on. Once integrated, the sub-documents are mapped to existing structures defined for the document class and/or sub-document type. Finally, the mapped textual elements are used to generate an index, or alternatively, the textual elements are inserted directly into a structured data repository, such as a database.

### BACKGROUND

The present invention relates to the processing and analysis of semi-structured textual data. In particular, the present invention relates to an apparatus and method for pre-processing semi-structured textual data for the purpose of enhancing its use as a data source by analytical processing tools.

Data analysts and decision makers in corporate, government and educational organizations commonly classify data into one of three categories: structured data, unstructured data, and semi-structured data. These three types of data have very different characteristics and are therefore used differently in the decision making process. Structured data, which is sometimes referred to as transactional data, is data that has been formatted or organized in some manner to best suit a particular processing task. For instance, the data involved in a typical banking transaction is an example of structured data. As a check is cashed or a withdrawal at an automated teller machine (ATM) is processed, the data generated and recorded is formatted and organized to suit the particular transaction. As another example, consider the data involved in an airline reservation system. Each time a customer purchases an airline ticket, a reservation is processed. The data collected by the reservation system is organized and stored in a particular format and structure. The nature of structured data makes it well suited for use with computers. Consequently, a great number of analytical processing tools (e.g., query generating/processing tools) have been developed for the specific purpose of analyzing structured data.

Unstructured data, and in particular, unstructured textual data, is data that has been generated without consideration for any particular rules for the writing or recording of the data. Some simple examples of unstructured textual data are email and medical records. With the exception of everyday grammatical rules, there are no rules an author must follow that specify a particular format or structure to be used, when writing the text of an email. For instance, when constructing an email, a person can write anything that the person pleases and can write in any language that the person desires. Another common type of unstructured data occurs when a doctor makes notes during an encounter with a patient. The doctor is under no obligation to make the notes in any particular way. There are no structural or formatting rules that the doctor has to follow in making textual notes during a patient visit. Given its nature, without some advanced pre-processing, unstructured data is inherently not as useful as structured data for use as a data source by computerized analytical processing tools.

A third type of data is referred to as semi-structured data. Like unstructured data, semi-structured data is often generated without strict structural or formatting rules that ultimately determine its structure or format. However, unlike unstructured data, semi-structured data generally has some form of inherent structure that can be determined from viewing or analyzing the data. For instance, with semi-structured text, the author imparts some meaning on certain aspects or portions of the text by structuring or formatting the text in a particular way—in some cases, without consciously doing so. In many cases, semi-structured data exhibits a pattern of repeated textual components within the textual document.

Some examples of semi-structured textual data include inspection reports, chemical descriptions, and recipe collections. For instance, an inspection report showing the results of a series of inspections made over a period of time may comprise semi-structured textual data. Upon the completion of an inspection, an inspector makes an entry into a report. In this sense, the data is repeatable because there are many descriptions of inspections that have been made over a period of time. However, the data is in a textual, narrative format. Accordingly, the data has some characteristics of unstructured data because for any given report, the report can be written however desired.

Suppose an organization deals with many chemicals, and in so doing, utilizes a book to record a brief narrative about each of those chemicals. Because the book includes entries for one textual description of a chemical after another, the structure of the data exhibits a form of repetition, and generally has the characteristics of being structured. However, because each individual narrative is textual, the data exhibits characteristics common to unstructured data.

A third example is a recipe book or collection of recipes having several recipe entries. The book may be logically divided with chapters dedicated to certain types of recipes. Within each chapter, each recipe entry may have several components including a description, a listing of ingredients, and detailed directions or instructions on how to make the particular food item or dish. In this case, although the data are not technically structured, there is a definite implied or inherent structure that has been superimposed on the textual data, even though all of the textual data resides in a single document.

Despite exhibiting characteristics of structured data, semi-structured data in its natural form can not typically be utilized as a data source by those analytical processing tools that are widely available for querying structured data sources. For instance, it might be useful if a query could be executed against a collection or recipes—whether the recipes are in one document, or several documents—to determine all of the recipes in the document(s) that include a certain ingredient, for example, pineapple. However, because the recipes are in semi-structured form, they cannot easily be analyzed by a conventional analytical processing tool. Consequently, there exists a need for enhancing the use of semi-structured data as a data source for analytical processing tools.

### SUMMARY

Embodiments of the present invention improve the manner in which semi-structured textual data can be processed by analytical processing tools, such as query tools. In one embodiment, the present invention includes pre-processing logic for pre-processing semi-structured textual data, thereby placing the semi-structured textual data in a condition more suitable for use as a data source by one or more analytical processing tools. Consistent with one embodiment of the invention, a processing task for conditioning a body of semi-structured text generally involves two distinct phases. During the first phase, a number of processing directives are established by an analyst, and during the second phase, the processing directives are carried out by a pre-processing logic. During the processing phase, three processing stages occur. These processing stages can broadly be categorized as sub-document identification, integration, and index/database creation.

The following detailed description and accompanying drawings provide additional understanding of the nature and advantages of the present invention.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings:

FIG. 1 illustrates an example of a document containing semi-structured textual data, consistent with text that may be processed by an embodiment of the invention;

FIG. 2 illustrates the two primary phases of a method for conditioning semi-structured textual data for use as a data source for analytical processing tools, according to an embodiment of the invention;

FIG. 3 illustrates an example of a functional block diagram of a semi-structured textual data processing application, according to an embodiment of the invention; and

FIG. 4 is a block diagram of an example computer system and network for implementing embodiments of the present invention.

### DETAILED DESCRIPTION

Described herein are techniques for enhancing, conditioning or converting a semi-structured text for use as a data source by one or more analytical processing tools. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

In one aspect, the present invention provides a method and apparatus for enhancing, conditioning, or converting a semi-structured text for use as a data source by a conventional analytical processing tool. Although an embodiment of the invention might be implemented entirely, or in part, in hardware, the embodiment of the invention described herein is implemented as a software application, or as part of a software application, executable on a computing system. As such, an embodiment of the invention may be implemented to operate on or with a wide variety of computer systems, and is independent of any particular hardware or software platform (e.g., processor, operating system and/or Database Management System (DBMS)). Furthermore, an embodiment of the invention processes or operates on semi-structured textual data. As the present invention is typically embodied in software, hardware, or a combination thereof, it will be appreciated by those skilled in the art that the semi-structured textual data on which an embodiment of the invention operates will be in an electronic or computer-readable format. Moreover, although generally described herein as operating with or on text that is written in the English language, the invention is language independent, and may be implemented to work with any language, including but not limited to: English, Spanish, French, German, and Russian.

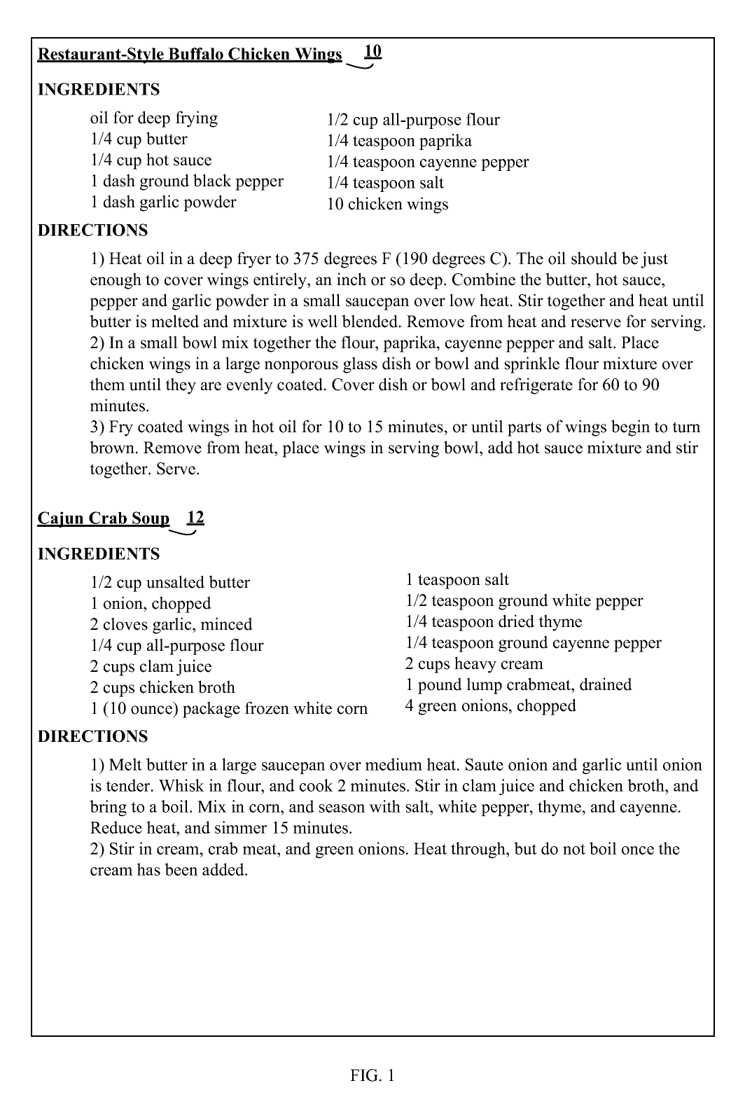

A semi-structured text (as described in greater detail above) is one in which there is some inherent or implied structure. Often, a semi-structured text will have some aspect, such as a portion of text, which repeats in some pattern throughout the text. When present, this repetitive pattern frequently provides additional information about certain characteristics, textual elements, or portions of the text. For instance, one example of a semi-structured text is a collection of recipes, such as that illustrated in FIG. 1. For purposes of illustrating and describing the invention, FIG. 1 includes only two recipes of what might be hundreds or more recipes provided in one or multiple documents. As illustrated in FIG. 1, each recipe in the collection of recipes has a distinct beginning and end point. In this case, the title of the recipe (e.g., “Restaurant-Style Buffalo Chicken Wings” 10 and “Cajun Crab Soup” 12) signals the beginning of one recipe, and thus the end of a previous recipe. In addition, each recipe has a listing of ingredients, as well as directions indicating how to make the particular food item. Although not shown in FIG. 1, each recipe in a collection of recipes may have other components as well, such as a general description of the recipe including background information about its origin, and so forth. From the example of FIG. 1, it is apparent that a collection of recipes—an example of semi-structured textual data—has some inherent structure that a user can quickly ascertain from a simple visual analysis of the document. Furthermore, the inclusion of a particular word or phrase in a particular section of the document provides some hint as to the meaning of the word or phrase. For instance, a word or phrase listed in the “Ingredients” section of the recipe collection suggests that the particular word or phrase is a food item or ingredient of the recipe.

Utilizing an embodiment of the invention, a user or analyst (used synonymously herein) determines a particular objective he or she would like to achieve by processing one or more documents containing semi-structured textual data. The particular objective that an analyst hopes to achieve via a processing task will vary depending on a variety of factors. However, in general, a processing task involves analyzing and processing semi-structured textual data in order to manipulate the text so as to make the text useful as a data source for conventional analytical processing tools. For instance, certain words or phrases may be extracted from a semi-structured text and inserted into an index or relational database table, thereby allowing the text to be subject to user-initiated queries. Furthermore, the index or table may ultimately by inserted into a larger data repository, such as a data warehouse.

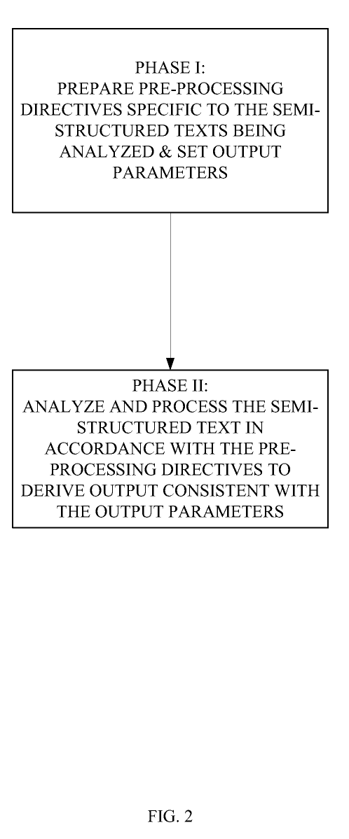

As illustrated in FIG. 2, in general, a method consistent with an embodiment of the invention involves two distinct phases. The first phase (e.g., Phase I in FIG. 2) involves preparing the pre-processing directives that will be used by the pre-processing logic to analyze and process the semi-structured textual data, and setting or configuring output parameters that determine the format of any output generated by the pre-processing logic. As described in greater detail below, the pre-processing directives are the mechanism used by the user or analyst to describe to the pre-processing logic the characteristics of the documents being analyzed and processed. Accordingly, the pre-processing directives may be specific to a certain document type or class (e.g., recipes), or may have broadly defined commands or rules that work with many document types or classes. In any case, the pre-processing directives ultimately determine how the semi-structured textual data is processed by the pre-processing logic. Similarly, the output parameters indicate to the pre-processing logic how any output resulting from the processing should be formatted and/or structured.

After the pre-processing directives have been specified, the second phase (e.g., Phase II in FIG. 2) involves the actual processing of the semi-structured textual data. As described in greater detail below, a pre-processing logic reads into memory the semi-structured textual data, processes the text in accordance with the pre-processing directives, and outputs the resulting pre-processed text in accordance with one or more output parameters. The processing performed by the pre-processing logic may be automatic, without user intervention, or alternatively, the processing may be interactive, such that a user intervenes at various points during the processing to provide further input.

The second phase (i.e., the processing phase), which involves the actual analysis and processing of the semi-structured textual data, can itself be thought of as occurring in three separate steps or stages. During the first processing stage, the semi-structured textual data is analyzed to identify broad patterns or repeated structural components in the semi-structured textual data. These repeated structural components are referred to herein as sub-documents. For instance, in the case of a recipe collection, each recipe entry may have a listing of ingredients. This listing of ingredients may qualify as a sub-document for a particular processing task.

Once the sub-documents are identified, the second stage of the processing phase involves integrating the semi-structured textual data. In general, integrating the text involves analyzing the text for the purpose of adding, changing or converting certain textual elements or portions of the text to ensure that the text is consistent with some pre-defined standards or conventions defined for the particular processing task. For instance, if the ultimate objective of the processing task is to analyze semi-structured textual data to create a database table for different recipe ingredients, it may be necessary to convert the name of a particular food item, which may be known by several different names, to a single conventional name. Additionally, if some food items are described in metric quantities (e.g., 1 liter of milk), it may be necessary to convert the quantity to another measurement system, for example, the English system of measurement. This type of conversion is achieved during the integration stage.

In one embodiment of the invention, the integration stage may involve many separate processing tasks. For instance, misspelled words in the semi-structured text may be corrected, or, alternative spellings of certain words may be modified. The text may be filtered to eliminate certain irrelevant words. Certain stop words, such as “a”, “and” and “the” may be removed. Certain words or phrases having common synonyms may be converted to, or replaced with, those synonyms. Homonym resolution may occur. For instance, homonyms—words or phrases that share the same spelling and pronunciation but have different meanings—may be supplemented with additional text to indicate the particular meaning based on the context in which the homonym appears. These are simply some examples of the types of processing tasks that may occur during the integration stage of the processing phase.

During the final stage of the processing phase, the semi-structured textual data is manipulated to generate a final output suitable for the particular processing task. For example, during the final stage, words and phrases from the semi-structured textual data may be mapped to various user-defined data structures. This may occur, for instance, on a sub-document level, such that each previously identified sub-document is analyzed to “populate” a user-defined data structure, such as an index or table, with textual elements from the semi-structured textual data. As described in greater detail below, the resulting output can be generated in a wide variety of formats to suit any number of analytic processing tools. The resulting output may be combined, or linked in some manner, with data from one or more other sources, including structured data sources. Furthermore, the resulting output may ultimately be inserted into a data repository, such as a data warehouse, where it can serve as a data source to conventional analytical processing tools.

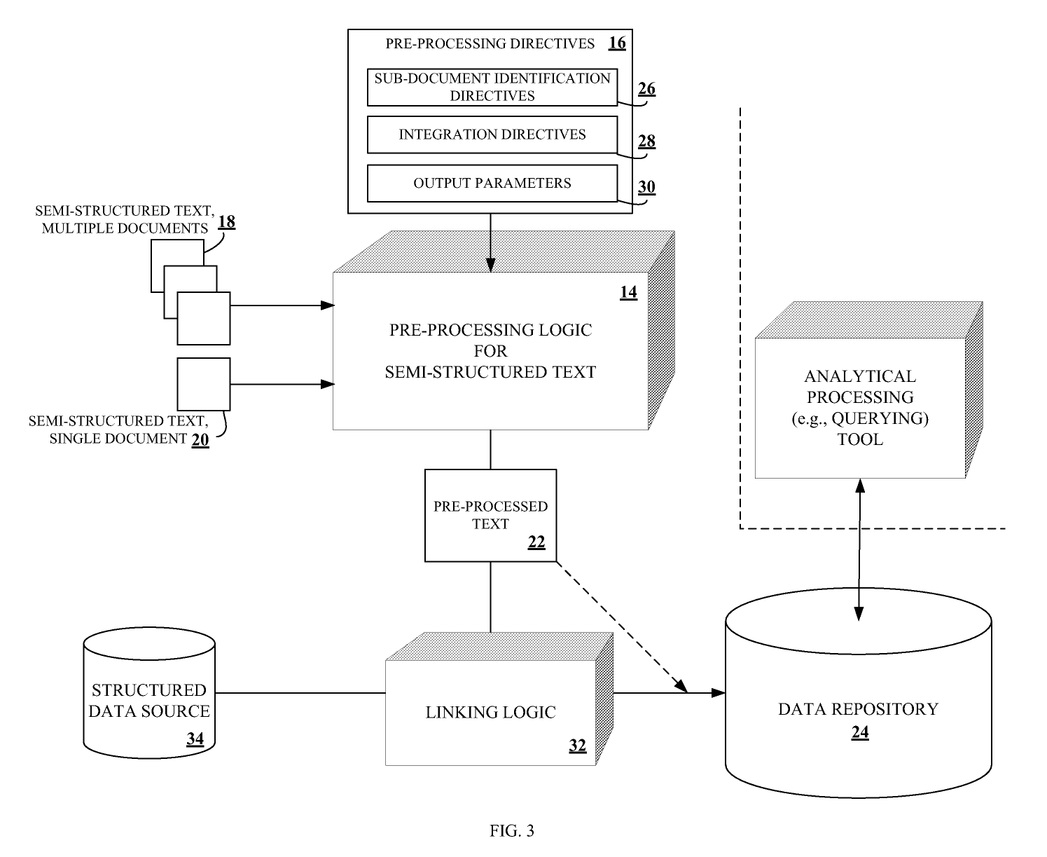

FIG. 3 illustrates an example of pre-processing logic 14, according to an embodiment of the invention, for pre-processing semi-structured textual data to improve the text's use as a data source for analytical data processing tools. In general, the pre-processing logic 14 processes documents containing semi-structured textual data in accordance with one or more pre-processing directives 16 specified by an analyst. The processing directives and operations described herein are referred to as pre-processing directives and operations in view of the additional processing that occurs after the semi-structured text(s) have been conditioned for use as a data source for one or more analytical processing tools 20.

As illustrated in FIG. 3, the pre-processing logic 14 takes as input one or more semi-structured texts (e.g., single document 18 or multiple documents 20) and a set of pre-processing directives 16, processes the semi-structured text(s) in accordance with the pre-processing directives 16, and then outputs the pre-processed text 22 to a data repository 24. In one embodiment of the invention, the pre-processing logic 14 may operate in one of two different document processing modes. In the first document processing mode, the pre-processing logic 14 may be configured to operate on a single document, as illustrated by the single document 18 shown in FIG. 2. In a second document processing mode, the pre-processing logic 14 may be configured to operate on multiple documents successively. Accordingly, when set to operate in multiple-document processing mode, the pre-processing directives 16 specified by the user will be used by the pre-processing logic 14 for the entire group or collection of documents 18 processed.

In one embodiment of the invention, the pre-processing logic 14 may have additional configuration settings allowing for additional operating modes. For instance, in one embodiment, configuration settings may allow a user to set operating modes that determine the level of autonomy by which the processing occurs. For example, in a fully-automatic mode, the processing of the semi-structured textual data occurs essentially uninterrupted without user intervention. However, other user-specified modes may enable the user to intervene at certain times in the process to manually provide input (e.g., to correct an anomaly), analyze or verify some aspect of the processing. The manual manipulation of data is often achieved with a particular processing tool, and is described in greater detail below.

The pre-processing directives 16 are in essence, commands, instructions, rules, or parameters established by a user and used by the pre-processing logic 14 to perform a particular processing task. The pre-processing directives 16 may be specific to a certain document type or class, or may have broadly defined commands, instructions or rules that work with many document types or classes. For instance, a particular pre-processing directive for processing a collection of recipes may include recipe-centric rules with names of foods, and so on. Accordingly, after a user or analyst has generated a set of pre-processing directives specific for a particular set of input documents or files, the pre-processing directives may be organized and saved for later use. Furthermore, in one embodiment of the invention, a pre-processing directive 16 may be generated using a customized editing application with a graphical user interface, thereby allowing a user to quickly create new pre-processing directives, and/or edit and manipulate existing pre-processing directives.

In general, the pre-processing directives 16 are the mechanism used by the user or analyst to describe characteristics of the documents being processed to the pre-processing logic 14. As illustrated in FIG. 3, the pre-processing directives 16 are shown grouped in one of three categories corresponding with the particular processing stage to which the directive is associated. For instance, as illustrated in FIG. 3, three broadly-defined categories of directives are shown, sub-document identification directives 26, integration directives 28, and output parameters 30.

A pre-processing directive in the sub-document identification category is one that provides a command, instruction, rule or some parameter that is used by the pre-processing logic 14 to determine what portions of text in the semi-structured textual data comprise sub-documents. There are several mechanisms that may be used to identify the boundaries, or sub-document breaks, of a particular sub-document. For instance, in the case of safety inspection reports, each textual description of an inspection may start with a date. Accordingly, a pre-processing directive 16 may instruct the pre-processing logic 14 to identify dates specified in a particular format. For example, when the pre-processing logic discovers textual data in the form of YYYY/MM/DD, a new grouping of semi-structured data (e.g., a sub-document) is created. In this case, YYYY/MM/DD indicates the beginning of a new inspection report within the semi-structured textual data. Therefore the pre-processing logic 14 recognizes a new sub-document. In the case of a chemical book that contains chemical properties, a pre-processing directive 16 may indicate to the pre-processing logic 14 that a new grouping of text (e.g., a sub-document) begins when a chemical name preceded by an end of line character is identified. In other scenarios, a sub-document may be delineated by something as simple as a numbered list that is in the format of “nn.” There are in fact a great number of characteristics which may signal that a new sub-document has been encountered within the semi-structured textual data that is being analyzed. Accordingly, an analyst has great flexibility in defining pre-processing directives that indicate to the pre-processing logic 14 those characteristics that signal a sub-document break (e.g., beginning or end).

Referring again to the recipe collection example of FIG. 1, one sub-document may be defined for recipe ingredients, and another for recipe directions. Accordingly, a pre-processing directive may indicate a rule for identifying a sub-document associated with ingredients. In this case, the rule may indicate to the pre-processing logic 14 that the portions of text located between the headings “Ingredients” and “Directions” (e.g., sub-document breaks) are to be treated as recipe ingredients. Similarly, a rule may specify that the portions of text located after the heading “Directions”, but before the title of the next recipe (e.g., “Cajun Crab Soup”), are to be treated as directions for making the food item. If, for example, an analyst notices that the font format for all recipe titles is bold with underline, this characteristic may be specified and utilized by the rule to determine the end of the sub-document for recipe directions. Accordingly, the analysis of the semi-structured textual data is not limited to the actual text, but may include analysis of character fonts and formats, special characters used for formatting (e.g., carriage return, paragraph breaks), and so on. Those skilled in the art will appreciate that both the format in which a pre-processing directive is specified, as well as the substantive rule of the pre-processing directive, may vary depending upon the implementation of the invention, and particular objective of the processing task.

Another type of pre-processing directive, referred to herein as an integration directive 28, may specify a rule or command for integrating certain textual elements of the semi-structured textual data. As indicated above, there are several different ways in which a semi-structured text may be integrated. For example, different pre-processing directives may be created for correcting or modifying the spelling of certain words, filtering text for relevancy, removing stop words, stemming certain verbs, and synonym and homonym resolution.

Integration is necessary because it improves the usefulness of the output pre-processed text as a data source to conventional analytical data processing tools. As a very simple example of the value of integration consider a pre-processing directive aimed at providing synonym resolution. As an example of synonym resolution, consider the words found in raw sources of semi-structured textual data—raw sources A, B, and C. A has the text “Ford”. B has the text “Hundai”. And C has the text “Porsche”. If the commonality of these words is not recognized then the search for data is impaired during the process of analytical processing. However, if the recognition is made that these words are all forms of a “car”, then a search can be made for “car” and the search will turn up the references to “Ford”, “Hundai”, and “Porsche”. In the context of searching, it is important for the specific form of a word to be recognized and the generic form of a word be recognized as well. Both the specific and the generic form of the word need to be able to be placed in a database that in turn goes into a data warehouse.

In one embodiment of the invention, the identification of the specific and the generic classes of data is accomplished through the usage of a taxonomy. When the raw text is read, if the word or phrase is determined to be a specific occurrence of a generic class, the taxonomy is used to determine what that generic class might be. In the example above, the pre-processing logic reads the raw data “Porsche”. In accordance with a particular pre-processing directive, the pre-processing logic will then look up the word “Porsche” in a taxonomy (e.g., a categorized listing or words) and find that a “Porsche” is a type of “car”. In generating the output, the pre-processing logic 14 will write out to a database the words “Porsche” and “car”.

Note that there may be more than one generic classification in which a certain word fits. It may be found that “Porsche” has more than one generic classification. A “Porsche” may be a “car”, a “race car”, a “luxury item” and so forth. The different generic classifications of textual data can be determined by more than one taxonomy. This may be achieved with one, or multiple, pre-processing directives. In order for the data to be placed in a database and/or a data warehouse, both the specific and the generic forms of the data need to be placed in the database and/or the data warehouse. Terms are introduced to the database and the data warehouse that may or may not be in the original raw document. The raw document may have the term “Porsche” but may not have the term “car”. However when the database for the data warehouse is created, both terms are placed in the database.

Another integration task achieved with pre-processing directives is that of homographic resolution. Homographic resolution is a way of noting the particular meaning of a word that may have several meanings. Consider that there are three raw sources of semi-structured data—A, B, and C. In A is found the text “ . . . there is a book by Bill Inmon on data warehouse . . . ” In raw source B there is the text “ . . . he recognized the bird by its distinctive bill, a large, blue protuberance . . . ” Finally, in raw source C there is the text “ . . . if you don't pay your bill I am going to . . . ”

In all three sources there is found the word “bill”. If the pre-processing logic 14 merely allows the word to pass with no further processing, it will increase the likelihood of confusion at the moment of analysis. If there is no further clarification as to the meaning of the words, the person Bill Inmon will be confused with the beak of a bird and the demand for payment for services and goods. Therefore it is desirable that homographic resolution be performed.

One way for homographic resolution to be achieved is for the analyst overseeing the processing task to read each source of data and determine the context of the source of the data. In document A the context is a biography. In the case of document B the context is ornithology. And in document C the context is accounting. The context of a document may also be established automatically by identifying a document class for a document. The document class may be identified by examining a document and looking for typical words that belong to the document class. In this particular example, the document class may be established by looking for words peculiar to the class, such as:
biography—born, died, married, education, mother, father, sister, etc.
ornithology—wings, feather, nest, migration, eggs, insects, worms, tree, etc.,
accounting—payable, receivable, interest, due date, penalty, balloon payment, foreclosure, etc.

In this case, the pre-processing logic 14 may read a document and search for terms that are peculiar to the document class. Upon determining the document class, the pre-processing logic 14 knows which interpretation to apply to the homograph. Once the context of the document is determined, the next step is to clarify the text as it is being written out to the database and then on to the data warehouse. The result of such a clarification might look like—A—“ . . . there is a book by the person/Bill Inmon on data warehouse . . . ” B—“ . . . he recognized the bird by its distinctive beak/bill, a large, blue protuberance . . . ” C—“ . . . if you don't pay your debt/obligation/bill I am going to . . . ” Note that the original word phrase is left in the text but new supplemental, clarifying text is added. Also note that the clarifying text that has been added did not necessarily appear in the raw text, even though the clarifying text is written out to the database as it passes its way into the data warehouse.

Both synonym resolution and homographic resolution are necessary for integration of raw text as the raw text passes into the database and then on into the data warehouse. There are many different ways that the integration stage allows the access and analysis of data to be done effectively. Accordingly, an analyst has great flexibility in defining pre-processing directives to facilitate the integration of the semi-structured textual data. Pre-processing directives for synonym resolution and homographic resolution are merely two ways in which the raw text may be integrated and prepared for entry into a database and ultimately, a data warehouse.

A third type of pre-processing directive, simply referred to herein as an output parameter 30, may operate to indicate the particular format or structure of any output generated by the pre-processing logic 14. As noted above, the pre-processed text 22—the resulting output of a processing task—can vary widely depending on the objective of the processing task. In general, the output pre-processed text can be created in one of many formats. One format is a simple database index. Another is a relational table containing both key and non key fields. Another is an index collected from many different collections of semi-structured textual data.

In one embodiment of the invention, the output pre-processed text 32 is first constructed as an index or table. Then, the index or table may optionally be linked in some manner—for example, by linking logic 32—prior to being inserted into a data repository 24, such as a data warehouse. Alternatively, the pre-processed text 22 may be inserted directly into the data repository 24. In one embodiment of the invention, the linking logic 32 analyzes the pre-processed text 22 and prepares it for use in a database, or data warehouse. For example, the linking logic 32 may prepare the instructions or code necessary to insert the data into the appropriate relational database tables with the appropriate data associations. In addition, the linking logic 32 may combine the pre-processed text 22 with data from another source (e.g., such as structured data source 34) prior to inserting the combined data into the data repository 24. For instance, the pre-processed text 22 may be combined with data from one or more existing database tables before it is inserted into the data repository. Although illustrated in FIG. 3 as a separate component, in one embodiment of the invention the linking logic may be integral with the pre-processing logic 14.

In one embodiment of the invention, the index or table that is generated by the pre-processing logic 14 is the result of processing a single document. That is, there may be a one-to-one correspondence between indexes generated and input documents. Alternatively, the pre-processing logic 14 may generate a single index or table as a result of processing a plurality of input documents. For instance, referring again to FIG. 1 and the example of a collection of recipes, if the pre-processing logic 14 processes multiple documents containing recipes, it may generate a single index for recipe ingredients based on an analysis of all of the documents processed. Each time a new document is processed, the recipe ingredients included in the document will be added to the index.

In general, there are two basic ways that an index or table may be built according to an embodiment of the invention. A pre-processing directive may specify a rule for identifying the words or phrases to be included in an index by specifying one or more variable symbols. Utilizing variable symbols, an instance of a variable is created each time a particular variable is identified in the text. A simple example is the text “ . . . name—Bill Inmon . . . ” The text “name” indicates that a variable symbol has been encountered and the instance, or value assigned to the variable, in this case is “Bill Inmon”. Accordingly, one or more pre-processing directives may be specified with variable symbols to map words or phrases in the semi-structured textual data to an index or database table.

The second way that variables for indexing are detected by the invention is through pattern recognition. Using pattern recognition, a variable is recognized because of the recognizable pattern the variable takes. By way of example, some common variable patterns include:
URL addresses—xxxx@yyy.com
Telephone numbers—999 999 9999
Social security numbers—999 99 9999
   Once a variable is recognized by its pattern, it is mapped to an index or table, in accordance with a pre-processing directive.

Once the semi structured data has been read, integrated, and placed into an index, the index may be conditioned for use with a particular technology platform. For instance, the data may be placed into a variety of technologies such as IBM's DB2, Oracle, Teradata, or NT SQL Server. In addition the resulting pre-processed text may be conditioned for use in popular software applications such as SAP BW or SAP NetWeaver.

One aspect of the invention is the ability to create output in a variety of formats. For example, by specifying various output parameters, an analyst can generate output for use with a wide variety of applications. There are different kinds of indexes that can be produced as a result of processing the semi-structured data. The analyst can control the form of the output and the content. Some general types of indexes that can be produced are as follows:
NAME=VALUE index—In this case, each entry in the index contains two fields—a NAME field and a VALUE field. The name field specifies which type of value is present in the sub-document and the VALUE field specifies an occurrence of the named field. As an example, there might be an occurrence of BIRTHDAY=Jun. 6, 1953. In this case, the name field is Birthdate and the Value field is Jun. 6, 1953.
VALUE ONLY fields—In value only fields, different fields are delimited by a common delimiter. As an example, there might be the data—John Jones, male, Jun. 6, 1953—as an entry into the index. Under this convention, the system would know by the order of the fields that the first field is name, the second field is gender and the third field is date of birth.

Where there are NAME=VALUE output fields, any output field may appear zero or more times for a given sub-document. Where there are VALUE only fields, the fields may be fixed in the order in which they are defined. In the simple example, name must always be the first field, gender the second field, and so forth. In VALUE only fields, if a given sub-document does not have a value, the system must supply a default value. To avoid inconsistent processing results, each sub-document should have one and only one entry for the sub-document.

Embodiments of the invention may find practical application in a number of contexts. For instance, an embodiment of the invention may aid in research, for example, in the medicine and health care industry. As health and medical records of data (e.g., doctors' notes) are created in a time sequenced manner, those notes can be captured, structured, stored and organized in a manner that enables quick and repeatable analysis to be performed. In the areas of customer relationship management (CRM) and customer data integration (CDI), customer communications initially captured in a semi-structured format may be processed and analyzed with an embodiment of the invention. Legal documents, such as legal contracts, patent and patent application documents, which are often in a semi-structured form, may be processed and analyzed utilizing an embodiment of the invention. Safety accident reports are often in semi-structured form, and are therefore candidates for processing and analysis by an embodiment of the invention.

As briefly described above, an embodiment of the invention may include several supplemental processing tools that allow a user to interactively manipulate data during the automated processing task. For instance, in one embodiment of the invention, a character scanning utility may assist an analyst in identifying special characters that determine the formatting of the document, but are not visible to a reader. For instance, special characters may include those used to signal an end of page, end of line, or tab. By using a character scanning utility to identify these characters, an analyst may specify a processing directive to recognize one or more of these special characters, or a pattern of these special characters, when analyzing text, for instance to identify a boundary of a sub-document.

Another utility that may aid an analyst in the processing of semi-structured text is a simple editing utility. An editing utility may be used at multiple points during the processing task. For instance, certain aspects of the semi-structured textual data may be “touched up” with the editing tool prior to processing to improve the accuracy with which the text is processed. Alternatively, the editing utility may be used post-processing to modify or correct the resulting text prior to inserting the resulting text into a data warehouse.

An input tool may also be utilized to specify the particular file paths for different documents that are to be processed. Of course, a variety of other tools may assist the analyst in improving the processing of semi-structured text, and such utilities may be invoked interactively by the pre-processing logic at various stages of processing.

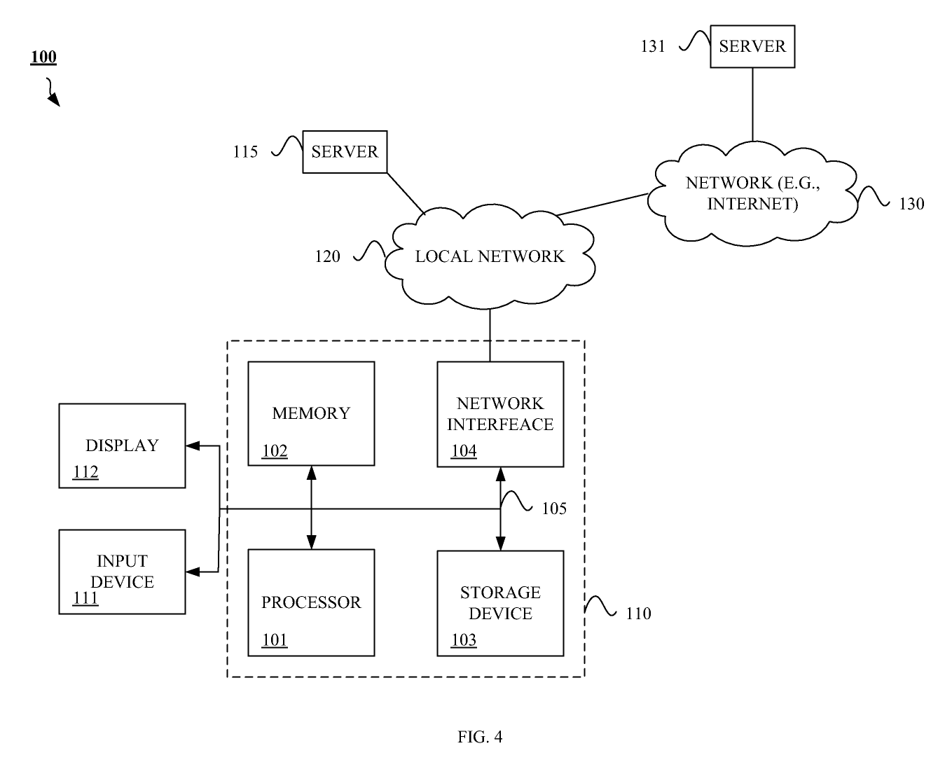

FIG. 4 is a block diagram of an example computer system and network 100 for implementing embodiments of the present invention. Computer system 110 includes a bus 105 or other communication mechanism for communicating information, and a processor 101 coupled with bus 105 for processing information. Computer system 110 also includes a memory 102 coupled to bus 105 for storing information and instructions to be executed by processor 101, including information and instructions for performing the techniques described above. This memory may also be used for storing temporary variables or other intermediate information during execution of instructions to be executed by processor 101. Possible implementations of this memory may be, but are not limited to, random access memory (RAM), read only memory (ROM), or both. A non-volatile mass storage device 103 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 103 may include source code, binary code, or software files for performing the techniques or embodying the constructs above, for example.

Computer system 110 may be coupled via bus 105 to a display 112, such as a cathode ray tube (CRT), liquid crystal display (LCD), or organic light emitting diode (OLED) for displaying information to a computer user. An input device 111 such as a keyboard and/or mouse is coupled to bus 105 for communicating information and command selections from the user to processor 101. The combination of these components allows the user to communicate with the system. In some systems, bus 105 may be divided into multiple specialized buses.

Computer system 110 also includes a network interface 104 coupled with bus 105. Network interface 104 may provide two-way data communication between computer system 110 and the local network 120. The network interface 104 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 104 sends and receives electrical, electromagnetic, or optical signals that carry digital data streams representing various types of information.

Computer system 110 can send and receive information, including messages or other interface actions, through the network interface 104 to an Intranet or the Internet 130. In the Internet example, software components or services may reside on multiple different computer systems 110 or servers 131 across the network. A server 131 may transmit actions or messages from one component, through Internet 130, local network 120, and network interface 104 to a component on computer system 110.

The above description illustrates various embodiments of the present invention along with examples of how aspects of the present invention may be implemented. The above examples and embodiments should not be deemed to be the only embodiments, and are presented to illustrate aspects and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

To further aid in conveying various aspects of the invention, attached hereto as Appendix A and B, and part of this specification, are user manuals for one particular implementation of a software tool that facilitates and/or embodies various aspects of the invention.

What is claimed is:

1. A computer-implemented method for conditioning semi-structured textual data for use as a data source for an analytical processing tool, the method comprising:
analyzing semi-structured textual data in accordance with one or more user-supplied pre-processing directives to identify an inherent structure within the semi-structured textual data;
based on the identified inherent structure, mapping textual elements from the semi-structured textual data to a user-specified structure in accordance with a particular user-supplied pre-processing directive, and
inserting the mapped textual elements of the semi-structured textual data into the data repository, thereby enabling the analytical processing tool to utilize those textual elements extracted from the semi-structured textual data as a data source.

2. The computer-implemented method of claim 1, wherein analyzing the semi-structured textual data in accordance with one or more user-supplied pre-processing directives to identify an inherent structure within the semi-structured textual data includes identifying sub-documents within the semi-structured textual data, each sub-document representing a portion of the semi-structured textual data which appears repeatedly within the semi-structured textual data.

3. The computer-implemented method of claim 2, wherein mapping textual elements from the semi-structured textual data to a user-specified structure in accordance with a particular user-supplied pre-processing directive includes mapping textual elements of a particular sub-document to a user-specified structure for that particular sub-document in accordance with the user-supplied pre-processing directive established specifically for that particular sub-document type.

4. The computer-implemented method of claim 3, wherein mapping textual elements of a particular sub-document to a user-specified structure for that particular sub-document includes assigning certain textual elements to a particular field of a user-defined structure when the certain textual elements satisfy one or more conditions specified in the user-supplied pre-processing directive established specifically for that particular sub-document type.

5. The computer-implemented method of claim 4, wherein inserting the mapped textual elements of the semi-structured textual data into the data repository includes first inserting the mapped textual elements into an index, and then adding the index to a larger data repository.

6. The computer-implemented method of claim 5, wherein prior to adding the index to the larger data repository, facilitating editing of the index so as to allow anomalies to be removed from the index.

7. The computer-implemented method of claim 1, wherein analyzing the semi-structured textual data includes integrating the semi-structured textual data.

8. The computer-implemented method of claim 7, wherein integrating the semi-structured textual data includes identifying those textual elements which may have one or more synonyms, and then resolving the synonyms by i) adding certain synonymous words to the semi-structured textual data, or ii) replacing the identified textual element with a particular synonymous word.

9. The computer-implemented method of claim 7, wherein integrating the semi-structured textual data includes performing homographic resolution for certain textual elements of the semi-structured textual data.

10. The computer-implemented method of claim 9, wherein performing homographic resolution involves identifying a particular meaning of a textual element that may have more than one meaning, and inserting additional text into the semi-structured textual data to indicate the particular meaning that has been selected for the textual element.

11. The computer-implemented method of claim 10, wherein the particular meaning of the textual element is selected based in part on determining a document class for the semi-structured text, and the document class is selected based on identifying certain textual elements within the semi-structured textual data that indicate the document class of the semi-structured text.

12. A computer-readable medium storing instructions, which, when executed by a computer, causes the computer to perform a method comprising:
analyzing semi-structured textual data in accordance with one or more user-supplied pre-processing directives to identify an inherent structure within the semi-structured textual data;
based on the identified inherent structure, mapping textual elements from the semi-structured textual data to a user-specified structure in accordance with a particular user-supplied pre-processing directive, and
inserting the mapped textual elements of the semi-structured textual data into the data repository, thereby enabling the analytical processing tool to utilize those textual elements extracted from the semi-structured textual data as a data source.

13. The computer-readable medium of claim 12, wherein analyzing the semi-structured textual data in accordance with one or more user-supplied pre-processing directives to identify an inherent structure within the semi-structured textual data includes identifying sub-documents within the semi-structured textual data, each sub-document representing a portion of the semi-structured textual data which appears repeatedly within the semi-structured textual data.

14. The computer-readable medium of claim 12, wherein mapping textual elements from the semi-structured textual data to a user-specified structure in accordance with a particular user-supplied pre-processing directive includes mapping textual elements of a particular sub-document to a user-specified structure for that particular sub-document in accordance with the user-supplied pre-processing directive established specifically for that particular sub-document type.

15. The computer-readable medium of claim 14, wherein mapping textual elements of a particular sub-document to a user-specified structure for that particular sub-document includes assigning certain textual elements to a particular field of a user-defined structure when the certain textual elements satisfy one or more conditions specified in the user-supplied pre-processing directive established specifically for that particular sub-document type.

16. The computer-readable medium of claim 15, wherein inserting the mapped textual elements of the semi-structured textual data into the data repository includes first inserting the mapped textual elements into an index, and then adding the index to a larger data repository.

17. The computer-readable medium of claim 16, wherein prior to adding the index to the larger data repository, facilitating editing of the index so as to allow anomalies to be removed from the index.

18. The computer-readable medium of claim 12, wherein analyzing the semi-structured textual data includes integrating the semi-structured textual data.

19. The computer-readable medium of claim 18, wherein integrating the semi-structured textual data includes identifying those textual elements which may have one or more synonyms, and then resolving the synonyms by i) adding certain synonymous words to the semi-structured textual data, or ii) replacing the identified textual element with a particular synonymous word.

20. The computer-readable medium of claim 18, wherein integrating the semi-structured textual data includes performing homographic resolution for certain textual elements of the semi-structured textual data.

21. The computer-readable medium of claim 20, wherein performing homographic resolution involves identifying a particular meaning of a textual element that may have more than one meaning, and inserting additional text into the semi-structured textual data to indicate the particular meaning that has been selected for the textual element.

22. The computer-readable medium of claim 21, wherein the particular meaning of the textual element is selected based in part on determining a document class for the semi-structured text, and the document class is selected based on identifying certain textual elements within the semi-structured textual data that indicate the document class of the semi-structured text.
